(19) United States
(12) Patent Application Publication
(10) Pub. No.: US 2024/0269675 A1
(43) Pub. Date: Aug. 15, 2024

(54) MOBILE AND AUTONOMOUS DEVICE AND METHOD FOR DETECTING ANALYTES IN THE AIR

(71) Applicants: Valerie COMPAN, Frontignan (FR); Sandie CHOQUART, Montpellier (FR)

(72) Inventors: Valerie COMPAN, Frontignan (FR); Sandie CHOQUART, Montpellier (FR)

(21) Appl. No.: 18/565,539

(22) PCT Filed: Jun. 3, 2022
(86) PCT No.: PCT/EP2022/065279

§ 371 Date: Nov. 30, 2023

(30) Foreign Application Priority Data
Jun. 6, 2021 (FR) FR2105927

(51) Int. Cl. B01L 3/00

(52) U.S. Cl. CPC B01L 3/502761; B01L 2200/0652; B01L 2200/143; B01L 2200/16; B01L 2300/0654; B01L 2300/168; B01L 2300/1822

(57) ABSTRACT

The mobile, autonomous device (10) for detecting analytes in air includes:
air inlet means (11),
means (12) for liquifying the only moisture present in the incoming air into droplets containing the analytes to be detected, in the absence of any input in the air stream whose humidity is subject to liquefaction,
means (13) for bringing droplets into contact with a plurality of markers, each marker presenting, after contact with a droplet containing an analyte to be detected, a physical quantity representative of the amount of this analyte present in the droplet,
means (14) for capturing the value of this physical quantity, configured to provide a signal representative of this physical quantity, and
means (15) for processing the signal from the capture means, configured to provide information representative of the concentration of each analyte to be detected in the incoming air,

Figure for the abstract: FIG. 1.

### TECHNICAL FIELD OF THE INVENTION

The present invention concerns a mobile and autonomous device and method for detecting analytes in air. It applies, in particular, to the detection in ambient or captured or exhaled air (by a human or animal) of one or more chemical and/or biological molecules/substances likely to be in air (e.g. bound or free proteins or protein fractions/lipoprotein glycoproteins etc.) and drugs or medicines or substances ingested or produced by the body (e.g. hormones), or toxins and pathogens or micro-organisms or single-cell organisms (e.g. viruses).

### STATE OF THE ART

Means exist for detecting analytes (e.g., viruses, bacteria, pathogens) present in a mixture of ambient air transferred into a liquid or fluid or liquid solution. These means are made up of several components, also called units or modules according to the invention. They can only be used by a trained operator.

These means mix components for disinfecting wastewater by pumping or ambient air to decontaminate it from odors by eliminating bacteria or viruses. See, for example, documents WO-2012056641 and WO-2017137862-A1.

Document WO-2018210128 is also known, in which the intake air is circulated through a liquid zone. Alternatively, the air can be mixed in liquid and gas, as described in WO-2012056641. The analytes are then detected from the mixture using a biochip or a fluorescent quantitative PCR technique.

Methods for detecting SARS-COV-2 involve number of separate steps: (i) sampling, (ii) sample processing, (iii) detection, (iv) visualization of the marker (v) obtaining the result (vi) interpretation of the results (vii) transfer of results to third parties. Each stage requires the intervention of an operator and university and hospital research laboratories. The samples taken are blood, saliva, or nasal extracts. For each of these methods, samples must be taken invasively and intrusively (swabs, etc.) by an operator.

In the prior art, air is mixed with a fluid to detect analytes. Analyte detection procedures use additional machines, which are separate from the liquid solution collection means. The detection procedures are carried out in several experimental steps.

This prior art does not allow the detection of analytes both in ambient air and from the exhaled air of living organisms including a human population or a single human whether newborn, young child, adolescent or of any age up to the very elderly.

Nor does this prior art allow, in parallel with the detection, to give a result within 1 to 5 minutes.

This prior art uses several large modules with detection means that are not suitable for individual or portable use by all humans of their child or adult age.

In the same context, some tests use methods that allow direct human visualization of the colorimetric marking of viral proteins via a cell phone camera. However, capturing the image of a marking by such a camera in an indeterminate light environment is detrimental to reliable interpretation.

In all cases, results are qualitative without being quantitative, and are not obtained immediately, but take at least 15 to 20 minutes.

Also known are the documents US 2013/244226, which describes nebulization and a liquid solution, US 2006/238757 and FR 2 968 082, which are based on an aerosol generator, and US 2015/377762, which teaches the use of an atomized fluorescent substance mixed with the patient's exhaled air, and particle impacts on a filter. These various techniques have the same drawbacks as the other prior art documents cited.

### SUBJECT OF THE INVENTION

The present invention aims to remedy some, or all, of these drawbacks.

To this end, the present invention relates to a portable, autonomous (self-contained) device for detecting analytes in air, which includes:
air inlet means,
means for liquefying moisture present in the incoming air into droplets containing the analytes to be detected, a means (12, 42) for liquefying moisture present in the incoming air into droplets containing the analytes to be detected, in the absence of any input in the air stream whose moisture is subject to liquefaction,
at least one means of bringing droplets into contact with a plurality of markers, each marker presenting, after contact with a droplet comprising an analyte to be detected, a physical quantity representative of the concentration of this analyte present in the droplet,
a means of capturing the value of this physical quantity configured to provide a signal representative of this physical quantity and,
means for processing the signal from the capture means, configured to provide information representative of the concentration of each of the analytes detected in the incoming air.

Condensation is the physical phenomenon of changing the state of matter from a gaseous state to a condensed state (solid or liquid). The transition from a gaseous to a liquid state is also known as liquefaction. The kinetics of this phenomenon are described by the Hertz-Knudsen relationship.

Thanks to these arrangements, the presence of a plurality of analytes is revealed and their concentration in the air is estimated. In particular, the liquefaction means makes it possible to obtain water from air without having to bring it in. There is no gas or liquid input to the air in which vapors are liquefied. The liquefaction means us the liquid issued from the liquefaction to hydrate air analyte detection markers. In embodiments, the device includes a first removable rigid module including the air inlet means, at least part of the means for liquefying moisture present in the air and at least one means for bringing droplets into contact with a plurality of markers, the removable rigid module comprising:
a base comprising a plurality of tubes each containing at least one analyte marker,
a neck connected to the base and configured for removably attaching the module to another part of the device,
an open apex connected to the neck, for the inlet of air to be treated.
a second removable module supporting a droplet collection surface from the tubes of the rigid removable air inlet module, the collection surface comprising a plurality of markers.

Thanks to these arrangements, this module can be manipulated autonomously to collect air containing targeted analytes, for example by exhalation on the part of the user or by positioning in a mini circuit of ambient air. This module is then assembled with at least part of the means for evaluating the value of the physical quantity. Additionally, these methods offer the advantage of easy cleaning, decontamination, and disinfection, since the module can be separated from the rest of the device. In embodiments, the device subject of the invention comprises a first removable rigid module including the air inlet means, at least part of the means for liquefying moisture present in the air and at least one means for bringing droplets into contact with a plurality of markers.

In embodiments, the first removable rigid module also includes at least one means for evaluating the concentration of analytes.

Analysis of the concentration of analytes enables their interpretation, not necessarily performed by an operator.

In embodiments, the removable rigid module includes:
a base comprising a plurality of tubes, each containing at least one analyte marker,
a neck connected to the base and configured to removably attach the module to another part of the device,
an open apex connected to the neck, for air intake.

In embodiments, at least one tube has a conical shape whose surface area decreases in the direction of air flow from the apex.

In embodiments, the device includes a second removable module supporting a surface for collecting droplets from the tubing of the rigid removable air inlet module, the collecting surface comprising a plurality of markers.

In embodiments, the droplet collection surface includes at least one reagent, and at least one internal control reagent which, labeling is higher than that of the other reagents and:
if the concentration measured on the control reagent is equal to that expected for air without analyte, and the concentration measured on another marker is comparable to the absence of reaction, the test is negative for the analyte corresponding to this marker,
if the concentration measured on the control reagent is higher than expected, and the concentration measured on another marker is lower than that measured on the control reagent and higher than no reaction, the test is positive for the analyte corresponding to this marker,
if the concentration measured on the control reagent is higher than expected, and the concentration measured on another marker is higher than that measured on the control reagent and higher than the absence of reaction, the test is positive for the analyte corresponding to this marker,
the concentration of control analytes is assessed using a standard curve.

In embodiments, the reagents on the collection surface are called “sensors”, enabling them to capture at least the concentration of analytes equivalent to the concentration of the said deposited sensor. The reagents stored in the tubing are also called “detectors” and, enable the concentration of the targeted analytes to be assessed using both the internal control and the standard curve.

Another means of evaluation is by learned comparison of images and results using artificial intelligence. The “detector” can also be used in certain cases of analytes to be detected without the “sensor”.

In embodiments, the device includes a support part including a housing for the first removable rigid module and a housing for the second removable module, configured to bring the end of the tubing of the first module into contact with the collection surface of the second removable module.

In embodiments, the part includes means for attaching a physical quantity capture module, opposite the housing of the first removable rigid module, through which the means for capturing the value of the physical quantity of each reagent.

In embodiments, the means for capturing the value of the physical quantity is a camera associated with at least one light source configured to ensure stable brightness.

In embodiments, the liquefying means includes a Peltier effect module.

In embodiments, at least one marker supports a freeze-dried reagent.

### BRIEF DESCRIPTION OF THE DRAWINGS

Further advantages, purposes and special features of the invention will be apparent from the following non-limiting description of at least one particular mode of production of the device, method and kit objects of the present invention, with reference to the appended drawings, in which:

FIG. 1 shows, schematically and in longitudinal cross-section from the side, a first peculiar embodiment of the device covered by the invention,

FIG. 2 represents, schematically and in top longitudinal section view represented by the section line “A-A” in FIG. 1, the device illustrated in FIG. 1,

FIG. 3 represents, schematically and in axial cross-section represented by section line “A-A” in FIG. 1, the device illustrated in FIG. 1,

FIG. 4 shows, schematically and in the side longitudinal section view, a second particular embodiment of the device covered by the invention,

FIG. 5 shows, in top view, a module of a third particular embodiment of the device subject to the invention,

FIG. 6 shows a perspective view of the third particular embodiment of the device subject to the invention,

FIG. 7 represents, in perspective, another module of the third particular embodiment of the device subject to the invention,

FIG. 8 shows, in the form of a flow chart, the steps involved in a particular embodiment of the process that is the subject of the invention, and

FIGS. 9 to 16 are graphs illustrating the test results of the device subject of the invention.

### DESCRIPTION OF EMBODIMENTS

The present description is non-limiting, as each feature of one embodiment can be advantageously combined with any other feature of any other embodiment.

The types of analytes to be processed and detected include, but are not limited to, cells, bacteria, viruses, nucleic acids, toxins, and other pathogens. By “analytes” we mean one or more chemical or biological molecules/substances likely to be in the air. Examples of analytes are bound, or free proteins or protein fractions/lipoprotein glycoproteins, drugs or substances ingested or produced by the body (e.g., hormones, etc.), toxins, pathogens or micro-organisms or single-celled organisms (e.g., viruses).

For Example:
an analyte may be derived from a natural or synthetic organic molecule, or from a micro-organism, virus, viral particles, bacteria,
an analyte may be derived from a natural or synthetic organic molecule, or from a prokaryotic and/or eukaryotic cell or organism of human, animal, or plant origin,
an analyte is an illicit or non-illicit psychoactive substance, e.g. cocaine, amphetamine and its derivatives, cannabis,
an analyte is a drug or its metabolites, or any organic substance that may be produced by ingestion.

Reagents, such as biological or chemical substances known as “markers”, e.g. bound or free proteins or protein fractions/glycoproteins, lipoproteins etc., or nucleic acid sequences (DNA or RNA) that can be prepared to be pre-bound by temporary fixation. These molecules interact with the analytes by modifying one of their physical quantities. The labelling reagents can be chosen from antibodies, themselves labelled using fluorescence, for example. The markers are preferably in solid form and are hydrated by the liquid resulting from the liquefaction of vapors present in the treated air.

“Collection means” refers to a means of transferring air into a tube, micro-tube, cone or micro-cone, or tubing, or channel of any suitable material (e.g., aluminum, copper, plastic, or resin, etc.).

By “droplet transfer means” we mean any means of containing a material in a liquid state.

“Revealing means” refers to any colored marking obtainable by any means capable of binding two molecules together by synthetic (e.g., immunoreactivity, hybridization, etc.) or natural (e.g., covalent, ionic, hydrogen or Van der Waals chemical bonds) methods and marking them to make them visible by any detection means.

By “solid support” we mean a support where the “revelation” of the signal is visible or perceptible (for example, molecules, membranes, chips, filters, etc.).

By “integrated detection means”, we mean a camera or micro-camera, or one using light, electric or electromagnetic current, etc.

Processing system” means any system for image analysis or analysis of a chemical, electrical or electromagnetic signal, etc.

The invention relates to a portable, customizable, self-contained, integrated sensing and detection device configured to detect in ambient or sensed or exhaled air (e.g. from humans and animals) at least one analyte.

The device consists of collected air processing, transfer and control means configured to control the processing of the air sample, so that detection of one or more types of analytes is fully automated in the integrated system. The transfer and collection means are preferentially reusable and recyclable.

The analyzed air (initially hot or cold) is sent into the device where it is transformed into drops containing at least water by a cooling means, possibly followed by a heating means.

The water resulting from vapor liquefaction in the air is used not only to capture the analyte(s), but also to reveal the labeling by the reagents. The water droplets are conveyed (transferred) onto a solid support with analyte detection means. As an alternative, before being transferred to this support, a conduit through which the drops circulate and/or to a second deposition support identifiable by a marking means, e.g., bar code, QR code (registered trademark, acronym for “Quick Response code”), the water drops can be previously transferred to microbeads in or on which reagents are stored that react with the analytes to be detected. Preferably, the system includes reagent storage means. The reagents are dissolved by water recovered from the air. The device includes an automatic measurement system for evaluating the concentration of each analyte.

The signal capture system, for example based on a camera and LED lighting, is miniaturized. Autonomous image processing enables evaluation of the concentration of each sought-after analyte. The stand-alone image processing system is a computer program for obtaining values corresponding to the concentrations of each analyte. The system can store the data obtained, and integrate it with other external values captured so that they can be processed by artificial intelligence in real time or at a later date.

Advantages of the present invention include all or part of:
air is used without mixing it with a fluid,
the analyte in the air is detected directly: the device does not require salivary, nasal or blood sampling; the device is therefore non-invasive and non-intrusive,
the concentration of the analyte is obtained: the result is therefore quantitative,
several air analytes are detected at the same time, enabling multi-analysis in the sense that several different analytes can be detected and quantified simultaneously,
each result is obtained in less than five minutes; an optional internal control means increases the reliability of each result,
the device is small and portable,
the results given are already interpreted for free use by the individual, whose identity is respected, along with his or her freedom to reveal or not the presence and concentration of analytes in the air, and their consequences in terms of health, protection and risk prevention.

The device has therefore been rendered “autonomous” in the sense that it does not require the intervention of a medical or specialist body or operator either for its use or for the interpretation of results. On the other hand, the results can be communicated to a doctor or safety specialist for incorporation into a professional diagnosis.
this device is so safe that it can be used by a child or an elderly person. It can also be used by a person with a disability, such as sight or hearing loss. For example, it is possible to print the data by connecting to a Braille mini-printer and/or to make the result audible by voice synthesis,
the present device preferably has a detachable part so that it can be used by several people simultaneously.

Please note that the figures are not to scale.

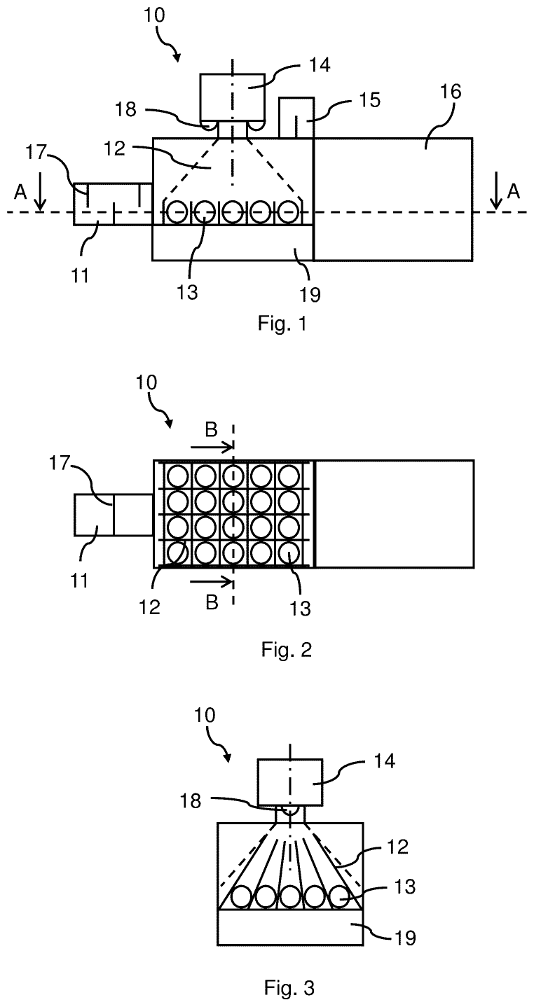

FIGS. 1 to 3 show three schematic views of an embodiment 10 of the device covered by the invention. The mobile, self-contained device 10 for detecting analytes in the air comprises an air inlet means 11. As described elsewhere, this air inlet means 11 is a means (a particular nozzle or whistle) through which a user blows. This means may or may not be connected to a pump to draw in ambient air if the air is not exhaled air. Preferably, and as illustrated in FIGS. 1 and 2, the air inlet circuit is sinuous and passes through dark optical baffles 17 preventing stray light from entering the device 10.

Device 10 also features a means 12 for liquefying moisture present in the incoming air into droplets containing the analytes to be detected. In FIGS. 1 to 3, the liquefying means 12 consists of radiator fins connected to a cold generator 19, for example a Peltier effect module.

Device 10 also includes means 13 for bringing droplets into contact with a plurality of markers. In FIGS. 1 to 3, twenty markers are shown in the form of beads carrying or including twenty different reagents. Each marker presents, after contact with a droplet containing an analyte to be detected, a physical quantity representative of the concentration of this analyte present in the droplet. For example, this physical quantity is a color, a hue or a fluorescence or an electric current.

Device 10 also includes means 14 for capturing the value of the marker's physical magnitude, which varies as a function of the presence of an analyte and the concentration of that analyte. The means 14 is configured to provide a signal representative of this physical magnitude. In the first embodiment 10, the capture means 14 comprises an electronic camera and at least one light source 18 directed towards the markers 13 or positioned below the markers. As shown in FIG. 3, the fins 12 are preferably oriented towards the optical center of the sensor 14, so as not to obscure the markers.

An air outlet 15, also fitted with optical baffles, allows air to escape from the device 10. A means of processing 16 the signal from the capture means 14 is configured to provide information representative of the concentration of each analyte to be detected in the incoming air.

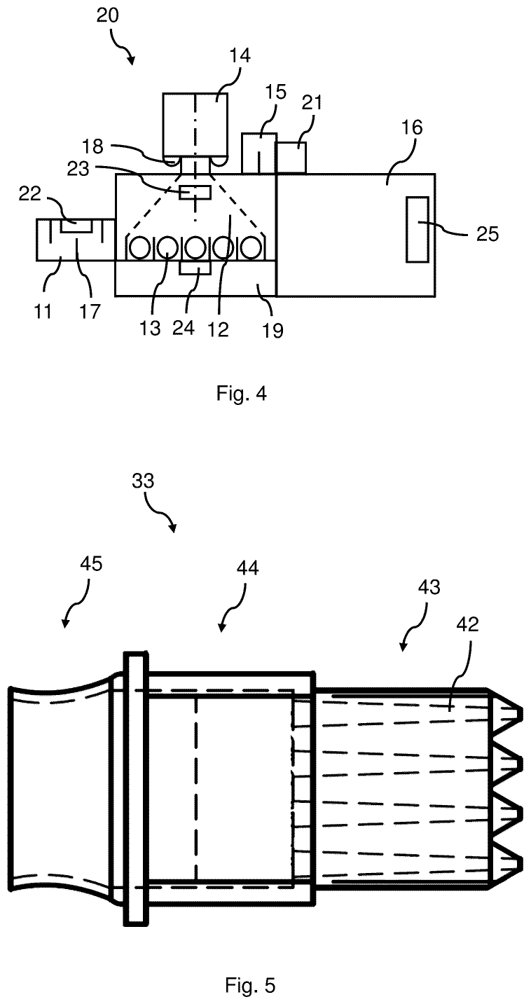

In the second embodiment 20 shown in FIG. 4, the elements of the first embodiment are repeated, with the addition of:
an air flow sensor 22, in air inlet 11 or air outlet 15 (configuration not shown),
a liquid quantity sensor 24, e.g., with a piezoelectric crystal which measures an amplitude of movement when vibrating,
an external temperature sensor 21,
an internal temperature sensor 23 and,
a device 20 verticality sensor 25.

The data supplied by the sensors can be used to validate or compensate for the results obtained by processing means 16. The verticality sensor 25 triggers an audible or visual alarm when the device is too inclined for the droplets to descend towards the markers 13.

It should be noted that the exhaled air flow meter 22 is used to evaluate the volume of air to be blown out by the patient and can also, by means of a luminous or audible display, indicate when the patient has reached the optimum volume of air for the treatment carried out by the device. The 22 flowmeter can also be used to estimate the expected volume of liquid over a given period of time.

The outside temperature and/or exhaled air sensor together measure the temperature of the patient's breath and therefore his or her body temperature. If the result varies according to the outside temperature, this can be compensated for algorithmically by means of a temperature sensor.

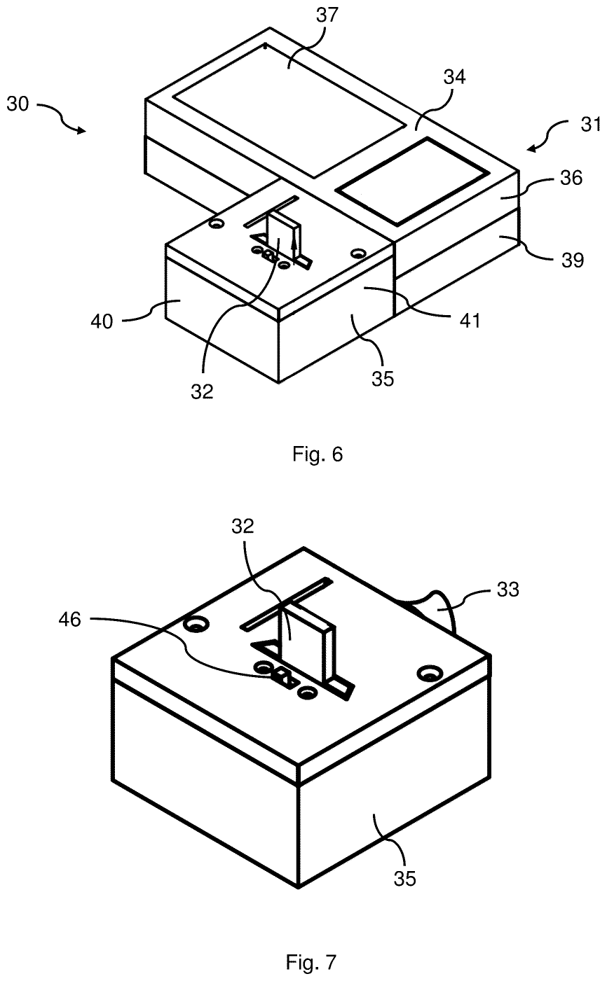

FIGS. 5 to 7 show a third embodiment 30 of the device under consideration.

With a third-mode 30 device, the inventors have achieved COVID19 detection within four minutes, in virtually all people who have been in contact, and systematically when they experience headaches and shortness of breath. Detection sensitivity is high, in the order of 100 ng/μl.

The central element of the device 30 is the module 33. The structure of module 33 is made of resin, plastic and/or metal. Three parts make up the module 33: the base 43, the neck 44 and the apex 45.

The base 43 is a right-angled block with rounded corners, for example with a height, measured from left to right in FIG. 5, of around 25 mm. The outside of base 43 is smooth. The exit face (right in FIG. 5) of base 43 may also have tapered ends. The inside of the base includes several tubes 42, typically at least eight tubes 42. In this embodiment, the tubes 42 are cone-shaped, for example with a diameter at the neck 44 of less than three millimeters and an outlet diameter of less than one millimeter.

The neck 44 i.e., the intermediate part of the module 33, has two faces, one of which is cylindrical, for example with a radius of 11.3 mm, and the other flat, with a height, measured parallel to the tubes 42 of at least 16 mm.

The open apex 45 is connected to the neck 44. One end of the apex 45 has a surface whose geometry is that of the neck 44. The other end of the apex 45 has an oval shape (seen perpendicular to FIG. 5 from the left of this figure).

In its function, module 33 serves to collect air and contain some of the reagents, and to cause interaction between the analytes in the air and the reagents.

The apex 45 is the first point of direct contact with the incoming air. The apex 45 and the neck 44 are places where the incoming air passes through. The base 43 contains one of the reagents in each tube 42.

The conical shape of the eight tubes 42 on base 43 is used to pre-treat the reagents, transforming them from a liquid to a solid state. It is in this solid state that the reagents are stored until use. Thus, module 33 is also the container for storing the reagents. The internal, conical shape of the tubes 42 in the base 43 of module 33 initially keeps the reagents in a liquid state. These reagents are then preserved and stored according to a primary and secondary lyophilization protocol adapted to the preservation of the reactivity of the specific reagents used.

The asymmetrical shape of the cylindrical neck 44, with its double cylindrical and flat sides, is used to orient the module 33 with respect to the solid support deposited in module 32 (see FIGS. 6 and 7). The asymmetrical shape of neck 44 also serves to orientate the deposition of reagents (molecules) on the solid support of module 32.

The shape of the Peltier module is at least 30 mm square. The Peltier module is almost in contact with module 33. Its function is to create a variable-temperature chamber (preferably close to 0° C. during transfer of incoming air) in the space of module 33.

The reagent support is twofold. On the one hand, it consists at least of module 33. On the other hand, the reagent support consists of a solid support deposited on a module 32. The solid support is at least a rectangle (e.g., 24.9 mm×19.9 mm). It includes, for example, a nitrocellulose membrane, possibly combined with mini compartments of glass fibers, or microbeads (electromagnetic or not). The solid support is contained in a housing of module 32.

The camera has a sharp resolution at 65 mm from the solid support located in module 32. The camera is in compartment 39. Its function is to capture the image of the solid support after air treatment and the reaction between analytes and reagents in homogeneous light conditions, whatever the external conditions, thanks to a suitable light source.

Module 32 contains the solid support, which is pre-treated to capture the analytes contained in the air.

It is module 33, inserted in part 35, which enables the air to be treated by modifying the temperature according to an air-cooling cycle. The user can blow out the air, if it is exhaled, but the air can be “propelled” by any means into the module 33 deposited in module 32. The droplets move under the pressure of the exhaled or propelled air and are deposited on the solid support of module 32. The pressure of the exhaled or pumped air, and the liquefaction of the vapor it contains, dissolves the reagents previously freeze-dried and thus preserved.

The air exits through the base 43, which is pierced by orifices in each tube 42 of the module 33.

Module 33 remains attached to part 35 of module 31 for up to three minutes. Module 33 is then removed from part 35 of module 31. Module 33 is then decontaminated, disinfected using a sterilization procedure and recycled for reuse.

The reagents are located both in the cones (tubes 42) of module 33 and on the solid support deposited in module 32. Alternatively, all the reagents may be deposited on module 32 only.

To prevent the reagents in the tubes (42) from being contaminated by the ambient air (in particular by dampening) before they are used, module 33 and module 32 are protected from contamination in sterile vacuum bags in the presence of desiccant bags.

The duration of the air blast or propulsion determines the near constancy of droplet volume. It is the concentration of reagents on the solid support that limits the bias of excess liquid, if any. The more the analyte is absent from the air, the more the reagents disappear. If it is present, it is fixed on the solid support of module 32, and the coloration remains fixed.

Part 35 comprises a housing for the first rigid removable module 33 and a housing for the second removable module 32. This part 35 is configured to bring the end of the tubing 42 of the first module into contact with the collection surface of the second removable module. Part 35 also includes means for attaching a physical quantity capture module 31, opposite the housing of the first rigid removable module 33, through which the means for capturing the value of the physical quantity of each marker.

The camera thus faces the opening in part 35 once module 33 has been removed to temporarily secure part 35 to module 31. The anti-reflective glass is positioned level with the opening of compartment 39.

The switch 46 on part 35 is used to switch on the temperature-varying modules.

The control reagent (synthetic molecules analogous to the captured analyte) is first deposited on the solid support of module 32. Its labelling is higher than that of the other reagents. The labelling intensity of the control reagent is converted into a concentration by a mathematical function. This concentration is doubly compared with that of a standard previously prepared in the laboratory and included in the computer program. This computer program is embedded in the intelligence contained in part 34. The results are as follows:
if the concentration measured on the control reagent is equal to that expected for air without analyte, and the concentration measured on another marker is comparable to the absence of reaction, the test is negative for the analyte corresponding to this marker,
if the concentration measured on the control reagent is higher than expected, and the concentration measured on another marker is lower than that measured on the control reagent and higher than no reaction, the test is positive for the analyte corresponding to this marker,
if the concentration measured on the control reagent is higher than expected, and the concentration measured on another marker is higher than that measured on the control reagent and higher than no reaction, the test is positive for the analyte corresponding to that marker,
the concentration of known analytes (controls) is evaluated and estimated using a standard curve.

As an alternative to using a camera to detect and then estimate analyte concentration, electromagnetic sensors can be used. Other modes of detection, including electric current, can also be used instead of a camera, for example.

The device of the present invention is at most of a size not exceeding 36 mm wide and 140 mm long. The device is therefore small. It is portable.

Device 30 includes module 31, made up of two detachable parts:
compartment 34, which can be shared between several people and,
part 35, detachable from part 34, which may or may not be shared with a given person.

Part 34 includes two compartments: compartment 36 contains a graphics card (not shown) and a screen 37, and has wired connections 38 for charging, HDMI, internet etc. Compartment 39 contains a sensor of physical magnitude, typically a camera, and a light source, preferably white, for example a light-emitting diode.

Image capture bypasses signal interpretation bias, at least colorimetrically and/or fluorescently. Compartment 39 is hermetically sealed via an anti-reflective glass pane.

Module 31 is preferentially connectable via WIFI (registered trademark).

Part 35 includes a power supply compartment 40, possibly connected to part 34, and an air treatment compartment 41. Compartment 41 has connectors for module 32 and module 33. Module 32 is also named as a “cartridge” and module 33 is also named as a “whistle”.

Together, modules 31 to 33 detect and measure at least one analyte in exhaled, ambient, or captured air.

Part 35 and module 33 constitute the means for collecting blown air or air collected by suction, condensed to a liquid state, and containing the analytes. In section 35, the water vapor in the air is condensed to a liquid state. Module 33 is also a means of transferring air condensed in the liquid state in the form of droplets to a solid support of module 32, on which reagents are placed.

Module 33 contains at least one means of revealing the label obtained from the interaction between the analytes and at least one of the reagents. This reagent is placed in module 33 in accordance with a conservation process for synthetic or non-synthetic biological molecules.

Module 31 is a system for processing and measuring the signal supplied by the sensor; it is arranged as follows:
part 35 is associated with module 33 by fitting, gluing, screwing, removable or non-removable,
the compartment 41 is associated with the module 33 by contact or non-contact juxtaposition,
the module 32 underlies the module 33 and the module 32 is removable and mobile (or stable) at least horizontally to face the detection means,
the module 33 is a solid support, removable or temporarily attached to the module 33 and/or the module 32,
the marking presence detection means is fixed (interlocking, gluing, screwing) to part 34 to detect the presence of the marking after exposing or pushing the module 32, or the module 32 left in the module 33, into part 34,
all these means are held together by part 35 containing the signal processing and measurement system; part 35 is fixed by interlocking, gluing, screwing, removable or non-removable to the signal processing and measurement system, which contains at least one processor for reading, controlling, and storing data,
the analyte(s) are revealed in real time,
a computer program supported by the graphics card automatically analyzes the captured image, interpreting it qualitatively and quantitatively, and evaluating the concentration of the analyte in real time,
the computer program includes translating the result into a code, such as a QR-code or barcode, so that it can only be interpreted by a third party wishing to guarantee the association between the identity of the blown air and the result.

Part 34 can be combined with several parts 35, to handle several blown, exhaled, or aspirated airs from different origins or sources at the same time. In this way, several people can be tested simultaneously.

In addition, module 33 and the solid support deposited on module 32 are preferably disposable or recyclable after cleaning, decontamination, and disinfection. Consequently, the only disposable element is the “solid support”, also known as the membrane of module 32.

For example, module 33 is made of resin used by dental technicians so that it never affects the skin or lips, since it can be worn in the mouth.

FIG. 6 illustrates how parts 34 and 35 of module 31 are hermetically joined, by sliding, screwing, or interlocking. FIG. 6 also illustrates how module 32 is slid into part 35 of module 31. Module 32 is mobile.

FIG. 7 illustrates how module 33 is positioned in part 35 of module 31 opposite module 32. Module 33 is slid, nested and/or screwed, for example, into part 35 of module 31.

Parts 35 can be replicated in greater numbers and connected mechanically and/or electronically and/or computerized to part 34. Compartment 39 of part 34 of module 31 can also be replicated to process air from several sources simultaneously.

The camera is localized in compartment 39 of part 34 of module 31. The camera is connected to the graphics card. The camera is associated with a light source for diffusing homogeneous light into compartment 39 of part 34 of module 31. The light used may include infrared light.

The recording is an image representing an interaction between at least two molecules. The image is processed using a program including image analysis processing as previously published in a completely different context of brain receptor analysis (Compan, Daszuta et al. 1996, Compan, Segu et al. 1998, Compan, Zhou et al. 2004).

The card e.g., Raspberry pi 3 or 4 (registered trademarks) implements the signal processing computer program.

The user can insert module 32 by himself, then use module 33.

After removing module 33, the user plugs in part 34 of module 31, and the result is displayed directly on the screen of part 34 of module 31.

Preferably, the solid support of module 32 is delivered in an envelope. The solid support is deposited by the user in the intended location of module 32.

The quantitative result together with other parameters (temperature, respiratory capacity, etc.) can be transferred under the user's authority directly to a doctor for diagnostic support. The result can also be transferred directly to the health authorities, or to the population protection authorities if the analytes are detected in the air of public places e.g., auditoriums, restaurants, educational establishments, means of transport, or if the analytes are detected in liquid or wastewater.

In FIG. 5, Module 33 has eight cones (or any other form of tubing) in two superimposed rows of four cones, matching the reagents in Module 33 with eight analytes sought simultaneously. Module 33 can include a greater or lesser number of tubes.

Modules 32 and 33 can be duplicated in the same way as parts 35 of module 31 to enable multiple analyses of air from different origins. A multiple analysis can therefore be performed by multiplying the parts 35 of module 31 and by multiplying modules 32 and 33, each of which can contain different categories of reagents for detecting different analytes.

The module 33 in the module 32 and this module 32 together condense the vapors present in the air into liquid by a system of context-dependent temperature variations, for example using the Peltier effect.

The solid support of module 32, onto which the droplets are transferred, is preferably chosen from a nitrocellulose membrane, possibly combined with mini compartments of glass fibers, or microbeads (electromagnetic or not).

The droplets are in contact with the reagents in module 33. Each cone of module 33 (or any other form of tubing) is positioned in correspondence with the reagents in each mini compartment of the solid support positioned in module 32.

Consequently, the reagents associated with modules 32 and 33 constitute screening kits that can be used with module 31. The present invention also covers such a kit.

In embodiments (not shown), the sensor of a physical quantity of the reagents that varies in the presence of an analyte is a sensor of electrical, thermal, optical, pressure, position, velocity, acceleration, and other signals.)

During storage of the collected data and results, these can be combined with other contextual data e.g., environmental factors, other diseases of the user, etc.

In some embodiments, reagents are only provided in the tubes 42 or on the support of module 32. The reagent deposited on the solid part of module 32 forms part of the sensor, and the reagent deposited in the tubing of module 33 forms part of a detector. The sensor provides at least one concentration of detected analytes. So, these detection and capture means provide two kinds of information: one of the existence of “at least one concentration”, and the other of a concentration evaluation with regard to the use of both the internal control and the standard curve.

The process comprises the following preliminary steps:
a) preparation of the reagents in modules 32 and 33,
b) deposition of the reagents on the solid support for fixing at least one reagent,
c) deposition of the solid support on module 32,
b) depositing reagents in module 33,
e) long-term storage of reagents in modules 32 and 33.

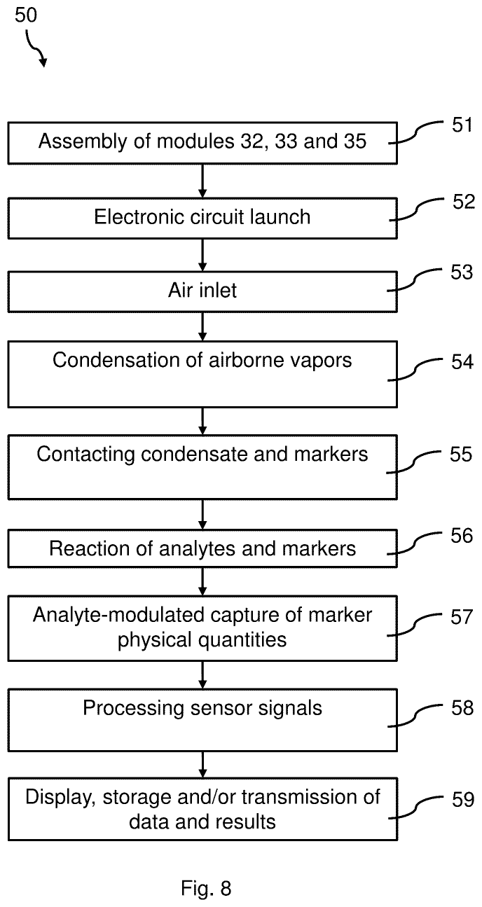

The process includes the following operating steps (see FIG. 8).

In a device configuration step 51, the user removes the shutter from part 35 and inserts module 32 into part 35 of module 31 and module 33 into part 35 of module 31. In a step 52, the user turns on part 35 with switch 46, thereby providing electrical power to the electronic circuits and the Peltier module.

In a step 53, air passes through the module 33. This air is blown in by the user or, expelled from a pump or sucked in by a pump or transferred from a pressure tank.

In a step 54, the air is treated with vapor liquefaction.

In step 55, the condensate is brought into contact with the reagent-bearing markers.

In step 56, the analytes react with the reagents from modules 32 and 33.

In step 57, the user removes module 33 from part 35 and assembles part 35 with part 34 without removing module 32 from part 35. A sensor, such as a camera, then captures a physical quantity representative of the reaction, such as color, hue or fluorescence.

In step 58, the on-board program processes the signal representing this physical quantity.

In a step 59, the device displays and stores in memory the results obtained. If the user wishes, these results can be transmitted remotely, for example to a doctor.

In embodiments, the process further comprises the following steps:
removal of collection and transfer modules 32 and 33 for cleaning, decontaminate and disinfect them for further use.
cleaning, decontamination, and disinfection of modules 31, 32, 33 and part 35.

The process may also include a step for statistical processing (repeated measures variance analysis by individual or group of individuals) of a large number of data. A section enabling data acquisition, anonymous storage, statistical analysis, and transmission of data to professionals. This step makes it possible to provide the best possible support to individuals, or to determine epidemic thresholds in the case of pathogen measurements.

In some embodiments, the solid support and module 33 are pre-treated to fix and preserve the reagents on the support. Alternatively, reagents are treated by freeze-drying.

### EXAMPLES OF USE

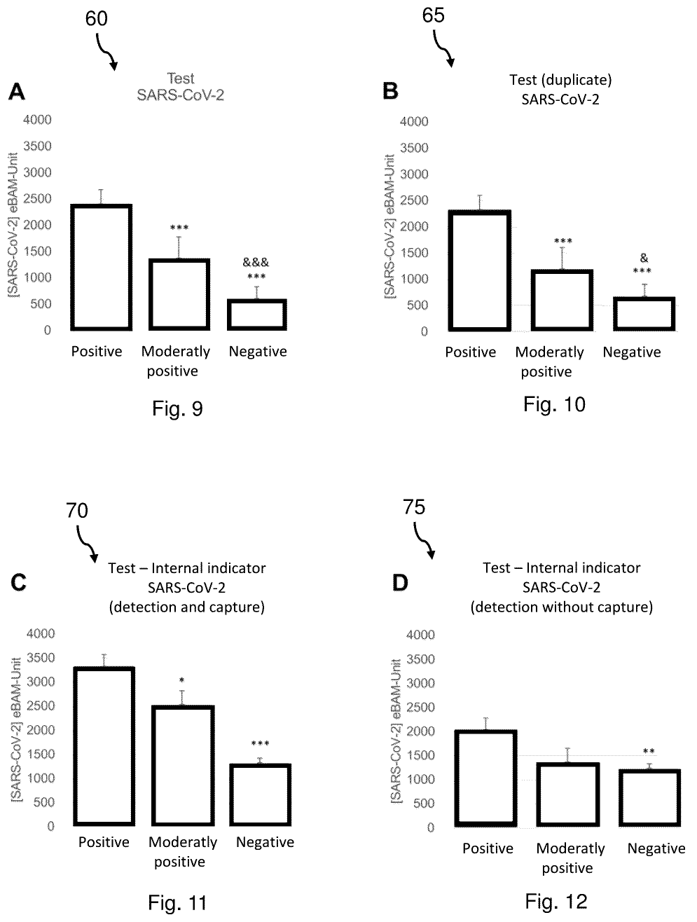

Using the particular embodiment of the device subject of the present invention described above, it has been possible to differentiate the following three groups of human subjects among 137 people tested in their living conditions, in parallel with the teams of the Agences Regionale de Sante (public administrative establishment of the French State in charge of implementing health policy in its region): 1. A group of subjects (n=45, 33%) exhaled high concentrations of viral particles (mean±s.e.m., the standard error of measurement, expressed in eBAM-Unit (unit adapted from mg/ml of viral particles): test 2399±205, duplicate test 2321±204/2399±205). This group of people is called “positive” (see left of graphs 60 and 65 in FIGS. 9 and 10). The mean SARS-COV-2 concentration of the internal control (pre-deposition of a defined concentration of SARS-COV-2: 1000 eBAM-Unit, in the presence of capture markers) of the positive group is all the higher the tests of the same subjects reveal their positivity (left in FIG. 11, graph 70). In the absence of capture biomarkers and prior deposition of SARS-COV-2, the virus is indeed less captured in positive subjects (left in graph 75 in FIG. 12).

2. A group of subjects (n=32, 23%) exhaled moderate concentrations of virus particles (mean±s.e.m. expressed in eBAM-Unit: test 1366±85, duplicate test 1192±44). This group of people is referred to as “moderately positive” (see center in graphs 60 and 65 in FIGS. 9 and 10). The mean SARS-COV-2 concentration of the internal control in the moderately-positive group is all the higher (mean 1000 eBAM-Unit) when the tests of the same subjects reveal their moderate positivity (see center of graph 70 in FIG. 11); and, to a lesser extent when capture biomarkers are omitted (see center of graph 75 in FIG. 12).

3. A group of subjects (n=60, 44%) exhaled viral particle concentrations at a level undetectable by the device (mean±s.e.m. expressed in eBAM-Unit: test 601±44, duplicate test 671±58). This group of subjects is referred to as “negative” (on the right in the graphs of FIGS. 9 and 10). The mean SARS-COV-2 concentration of the internal control of the negative group remains similar to the concentration value of the SARS-COV-2 part deposit of 1000 eBAM-Unit with or without capture (right in the graphs of FIGS. 11 and 12).

Thus, FIGS. 9 to 12 represent high (left) to undetectable (right) SARS-COV-2 concentrations assessed in real time by the device under investigation in the breath of 137 people in their living conditions.

FIGS. 9 and 10 show SARS-COV-2 levels in the presence of capture and detection biomarkers.

FIGS. 11 and 12 show SARS-COV-2 levels in the presence of previously captured SARS-COV-2, respectively in the presence and absence of specific capture and detection biomarkers.

In these figures ***p means <0.0001; **p means <0.001, differences between positive and moderate positive or negative, &&&p means <0.0001; &p means <0.05 differences between moderate positive and negative as a result of ANOVA followed by Tukey's test (positive n=45, moderate positive n=32, negative n=60).

### Preliminary Diagnostic Performance of the Device Subject of the Invention

Under experimental conditions where subjects are tested both by a reference test, and the test whose diagnostic performance is being used, the current standard for estimating the diagnostic performance of a quantitative biomarker is the AUROC (acronym for “Area Under the Curve Receiver Operating Characteristic”). This standard is a statistical analysis whereby the ROC curve obtained is used to assess the proportion of true positives versus false positives for the populations studied. In the present study, we have selected three criteria for:
i) Firstly, estimating whether the concentration of viral particles in the exhaled air of the same population of people (n=137) as previously described (FIGS. 9 to 12) was all the higher if the people declared, at the same time they were tested by the device, at least one of the following three criteria:
a) be or having been affected by COVID-19 confirmed by a positive PCR test,
b) show symptoms of COVID-19,
c) having been in contact with a person affected by COVID-19 during the 8 days preceding the day of the test.

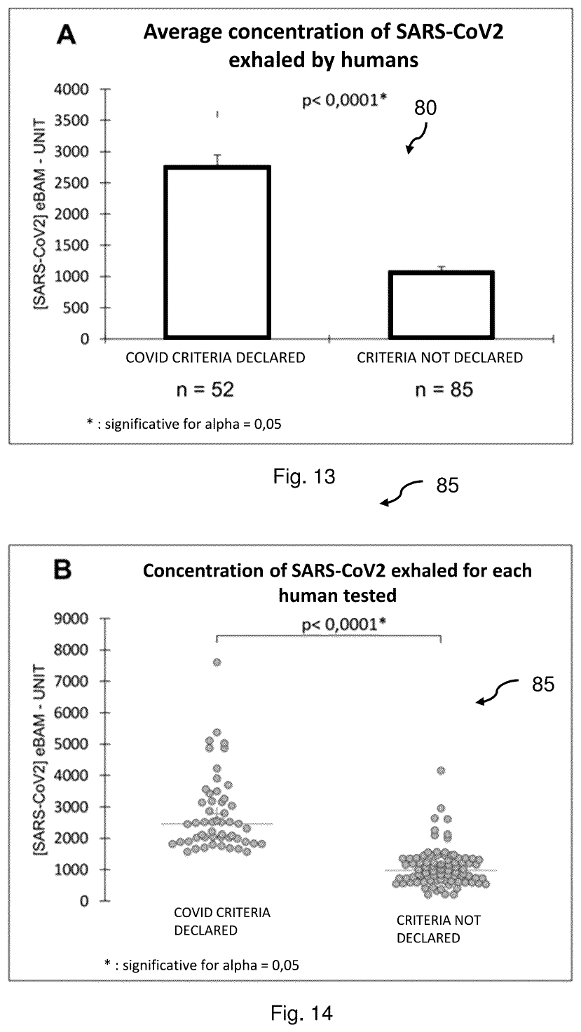

Hence the Creation of Two Groups:
one is called: “COVID CRITERIA DECLARED”, on the left in FIGS. 13 and 14,
the other is called “CRITERIA NOT DECLARED”, on the right in these figures.

The results of the device show that the concentration of viral particles exhaled by 137 people, as assessed by the device, is all the higher the more people declare one of the three aforementioned criteria (2735±173, mean±e. s.m. of SARS-Cov2 expressed in eBAM-Unit, FIG. 13) compared to those who do not declare one of the three criteria (1702±71, mean±e.s.m. of SARS-Cov2 expressed in eBAM-Unit, FIG. 13), as is also clearly illustrated by the data scatter diagram (FIG. 14). For subsequent analyses (see FIGS. 13 and 14), eight people in the “CRITERIA NOT DECLARED” group exhaled high concentrations of virus (FIG. 14). These people may be healthy (asymptomatic) carriers.

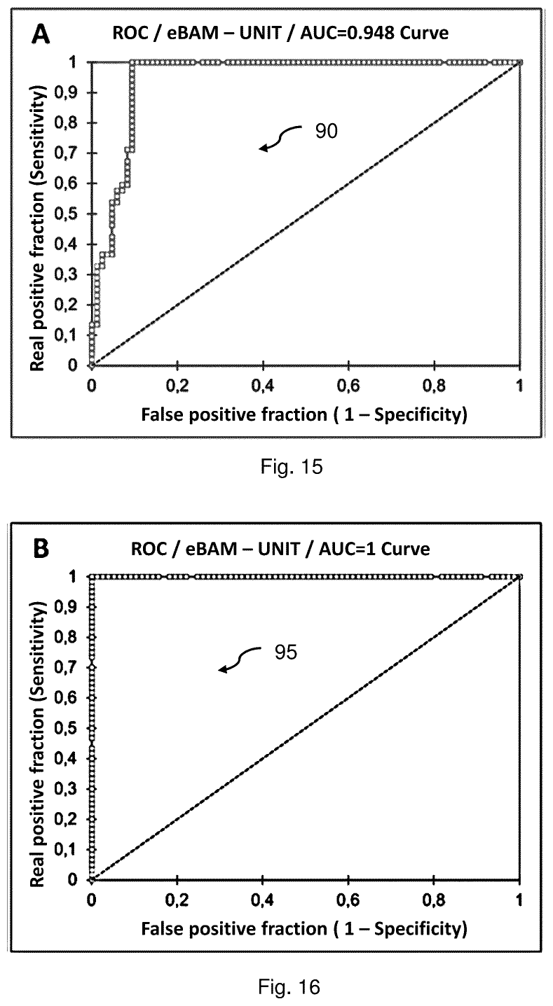

In FIGS. 13 and 14, the device detects higher concentrations of SARS-COV2 exhaled by subjects reporting at least one of the three COVID criteria, compared with non-reporters.
(A) Mean±s.e.m. SARS-COV-2 concentration expressed in eBAM-Unit in subjects who reported i) having been or being affected by COVID-19 or, ii) having symptoms of COVID-19 or iii) having been in contact with a person affected by COVID-19 on the day the device was tested (COVID CRITERIA DECLARED), compared with subjects who reported none of these three criteria (CRITERIA NOT DECLARED).
(B) Concentration of SARS-COV-2 in each person tested by the test device in the two CRITERIA COVID DECLARED or NON DECLARED groups of test subjects. In this test, p<0.0001 after Student's t-test.
ii) Secondly, to assess a preliminary diagnostic value of the device, considering the two groups “CRITERES COVID DECLARES” and “CRITERES NON DECLARES”. Two analyses were carried out to estimate the device's diagnostic value. FIGS. 15 and 16 show the AUROC analysis of the device tested:

FIG. 15: 52 “PROBABLE COVID” subjects from a total of 137 test subjects.

FIG. 16: 60 “PROBABLE COVID” subjects from a total of 137 people tested.
In the first case, we have included in the analysis eight subjects whose veracity can be questioned with regard to the declared criteria (included in the “undeclared criteria” group, but their exhaled virus concentration value is in the “positive” group). In this first case of analysis, the value estimated by the area under the ROC curve (AUROC) is 0.948 (FIG. 15), meaning that a subject actually carrying the virus will exhale a higher (elevated) concentration of virus than one who does not, in 95% of cases. With a prevalence of “PROBABLE COVID” cases of 38%, the negative predictive value (NPV) and positive predictive value (PPV) of the test device were 100% and 87% respectively. For a threshold value of 1569 eBAM-Unit, sensitivity was 100% (with a lower value of 92%) and specificity 91% (lower value: 82%, upper value: 95%) for the diagnosis of COVID-19.
In the second case, we excluded the said 8 subjects from the analysis by including them in the “COVID criteria declared” group. In this second case of analysis, the estimated value of the area under the AUROC curve is 1 (FIG. 16), meaning that a subject actually carrying the virus will exhale a higher (elevated) concentration of virus than a subject who does not, in 100% of cases. Here, with a prevalence of “PROBABLE COVID” cases of 44%, the negative predictive value (NPV) and positive predictive value (PPV) of the test device were both 100%. For a threshold value of 1569 eBAM-Unit, sensitivity was 100% (with a lower value of 92%) and specificity 100% (lower value: 94) for the diagnosis of COVID-19.

1. A mobile, autonomous device for detecting analytes in air, comprising:
air inlet means,
means for liquifying the only moisture present in the incoming air into droplets containing the analytes to be detected, a means for liquefying moisture present in the incoming air into droplets containing the analytes to be detected, in the absence of any input in the air stream whose moisture is subject to liquefaction,
at least one means for bringing droplets into contact with a plurality of markers, each marker presenting, after contact with a droplet comprising an analyte to be detected, a physical quantity representative of the amount of this analyte present in the droplet,
means for capturing the value of said physical quantity, configured to provide a signal representative of the said physical quantity, and
means for processing the signal from the capture means, configured to provide information representative of the concentration of each analyte to be detected in the incoming air.

2. The device according to claim 1, comprising a first removable rigid module including air inlet means, at least part of the means for condensing moisture present in the air and at least one means for bringing droplets into contact with a plurality of markers, the removable rigid module comprising:
a base comprising a plurality of tubes each containing at least one analyte marker,
a neck connected to the base and configured for removably attaching the module to another part of the device,
an open apex connected to the neck, for the inlet of air to be treated.
a second removable module supporting a droplet collection surface from the tubes of the rigid removable air inlet module, the collection surface comprising a plurality of markers.

3. The device according to claim 1, which comprises a first removable rigid module including the air inlet means, at least part of the means for liquefying moisture present in the air and at least one means for bringing droplets into contact with a plurality of markers.

4. The device according to claim 3, in which the first removable rigid module additionally comprises at least one means for evaluating analyte concentration.

5. The device according to claim 3, in which the removable rigid module includes:
a base comprising a plurality of tubes each containing at least one analyte marker,
a neck connected to the base and configured for removably attaching the module to another part of the device,
an open apex connected to the neck, for inlet of air to be treated.

6. The device according to claim 5, in which at least one tube has a conical shape whose surface area decreases in the direction of air flow from the apex.

7. The device according to claim 3, which includes a second removable module supporting a surface for collecting droplets from the nozzles of the rigid removable air inlet module, the collecting surface comprising a plurality of markers.

8. The device according to claim 7, in which the droplet collection surface includes at least one reagent, and at least one internal control reagent whose marker is higher than that of the other reagents and
if the concentration measured on the control reagent is equal to that expected for air without analyte, and the concentration measured on another marker is comparable to the absence of reaction, the test is negative for the analyte corresponding to this marker,
if the concentration measured on the control reagent is higher than expected, and the concentration measured on another marker is lower than that measured on the control reagent and higher than the absence of reaction, the test is positive for the analyte corresponding to this marker,
if the concentration measured on the control reagent is higher than expected, and the concentration measured on another marker is higher than that measured on the control reagent and higher than no reaction, the test is positive for the analyte corresponding to this marker,
the concentration of control analytes is evaluated using a standard curve.

9. The device according to claim 3, which includes a support part including a housing for the first removable rigid module and a housing for the second removable module, configured to bring the end of the tubing of the first module into contact with the collection surface of the second removable module.

10. The device according to claim 9, in which the support part includes means for fixing a module for capturing a physical quantity, opposite the housing of the first removable rigid module, through which the means for capturing the value of the physical quantity of each marker.

11. The device according to claim 1, in which the means for capturing the value of the physical quantity is a camera associated with at least one light source configured to ensure stable luminosity.

12. The device according to claim 1, in which the liquifying means comprises a Peltier effect module.
